(19) United States
(12) Patent Application Publication
(10) Pub. No.: US 2007/0250366 A1
(43) Pub. Date: Oct. 25, 2007

(54) Apparatus, method and computer program product for annotating a meeting in an electronic calendar

(75) Inventor: Mikko Nurmi, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/408,569

(22) Filed: Apr. 21, 2006

(51) Int. Cl. G06F 9/46

(52) U.S. Cl. 705/8

(57) ABSTRACT

A method includes displaying an invitation to a scheduled event, such as a meeting, and, in response to user input, indicating the user's desire to accept to attend, tentatively accept to attend or decline to attend selected portions of the scheduled event.

### TECHNICAL FIELD

The teachings in accordance with the exemplary embodiments of this invention relate generally to user interfaces for devices and methods pertaining to same and, more specifically, relate to calendar applications and to meeting requests.

### BACKGROUND

A problem that can arise during the organization and execution of a meeting, including phone conferences, of any significant duration (e.g., more than one half hour) is that people can attend the meeting and leave before the meeting ends. In accordance with current computer-based meeting schedulers and calendar applications, such as one known as Microsoft Outlook™, a given user (meeting invitee) can one of accept a meeting request, reject a meeting request, or set the meeting request as tentative. As shown in the example of FIG. 3, a certain meeting invitee has received three meeting requests (Meetings 1-3). The meeting invitee has accepted Meeting 1, has tentatively accepted Meeting 2, and has rejected Meeting 3. As may be appreciated, the current approach to scheduling a user's time with regard to one or more meetings is inflexible.

### SUMMARY OF THE EXEMPLARY EMBODIMENTS

The foregoing and other problems are overcome, and other advantages are realized, in accordance with the non-limiting and exemplary embodiments of this invention.

In accordance with the exemplary embodiments of this invention there is provided a method that includes displaying an invitation to a scheduled event and, in response to user input, indicating the user's desire to accept to attend, tentatively accept to attend or decline to attend selected portions of the scheduled event.

Further in accordance with the exemplary embodiments of this invention there is provided a computer program product that is embodied in at least one computer readable storage media and that comprises program instructions the execution of which by at least one data processor results in operations that include displaying an invitation to a scheduled event and, in response to user input, indicating the user's desire to accept to attend, tentatively accept to attend or decline to attend selected portions of the scheduled event.

Still further in accordance with the exemplary embodiments of this invention there is provided a device that comprises at least one data processor; at least one memory coupled to the at least one data processor; at least one interface to a communications network that is coupled to the at least one data processor; and a user interface coupled to the at least one data processor. The data processor is responsive to receiving from the communications network an invitation to a scheduled event from an inviter to store data descriptive of the invitation in the memory and to display the invitation to the scheduled event using the user interface, and is further responsive to user input received from the user interface that indicates the user's desire to accept to attend, tentatively accept to attend or decline to attend selected portions of the scheduled event for marking the displayed invitation accordingly.

Further in accordance with the exemplary embodiments of this invention there is provided a calendar/scheduling application operable in a device and comprising means for displaying an invitation to a scheduled event and means, responsive to user input, for indicating the user's desire to selectively participate in or not participate in selected portions of the scheduled event.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a simplified block diagram an embodiment of a wireless communications system having devices that are suitable for practicing the exemplary embodiments of this invention;

FIG. 2 is a logic flow diagram that is illustrative of a method in accordance with the exemplary embodiments of this invention; and

FIG. 3 shows examples of various meetings displayed in a calendar with an invitee's responses in accordance with conventional practice.

FIGS. 4 through 7 show non-limiting examples of various meetings displayed in a calendar with an invitee's responses in accordance with the exemplary embodiments of this invention.

### DETAILED DESCRIPTION

By way of introduction, the use of the exemplary embodiments of this invention improve and enhance current approaches to meeting requests. It is assumed that a first user (inviter) can create a meeting request and send it to one or more second users (invitees), using any conventional meeting request initiation procedure. In accordance with the exemplary embodiments of this invention, an invitee can selectively accept, tentatively accept, or reject a portion of the meeting. As a result, it becomes possible for the invitee to have meeting requests that he has accepted in part, rejected in part, and tentatively accepted in part.

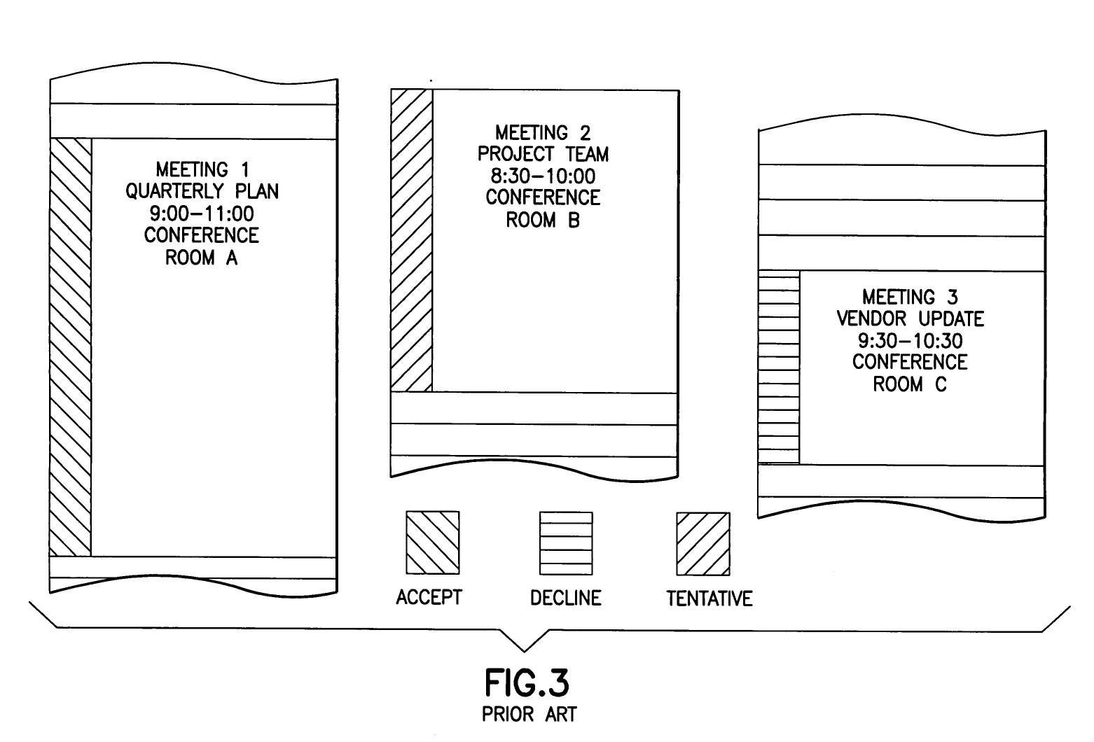

FIG. 3 shows the conventional case of calendar meeting requests in a computerized calendar application. As was noted above, the meeting invitee has accepted Meeting 1 in its totality, has tentatively accepted Meeting 2 in its totality, and has rejected Meeting 3 in its totality. Note that while these conditions are shown by cross-hatching, the use of different colors can be employed as well. In this conventional case there is provided no alternative where the invitee could accept part of a meeting request and reject another part of the meeting request, in the event that the invitee cannot or does not wish to attend the entire meeting. Further, there is no opportunity for a prospective attendee to indicate that s/he accepts or tentatively accepts participating in the meeting, either in whole or in part, by some means other than personal attendance. In some instances, meetings may be both in-person and teleconferenced or videoconferenced. The conventional electronic calendaring systems are not seen to offer the option of a participant indicating that they can participate by teleconference or videoconference rather than personal attendance.

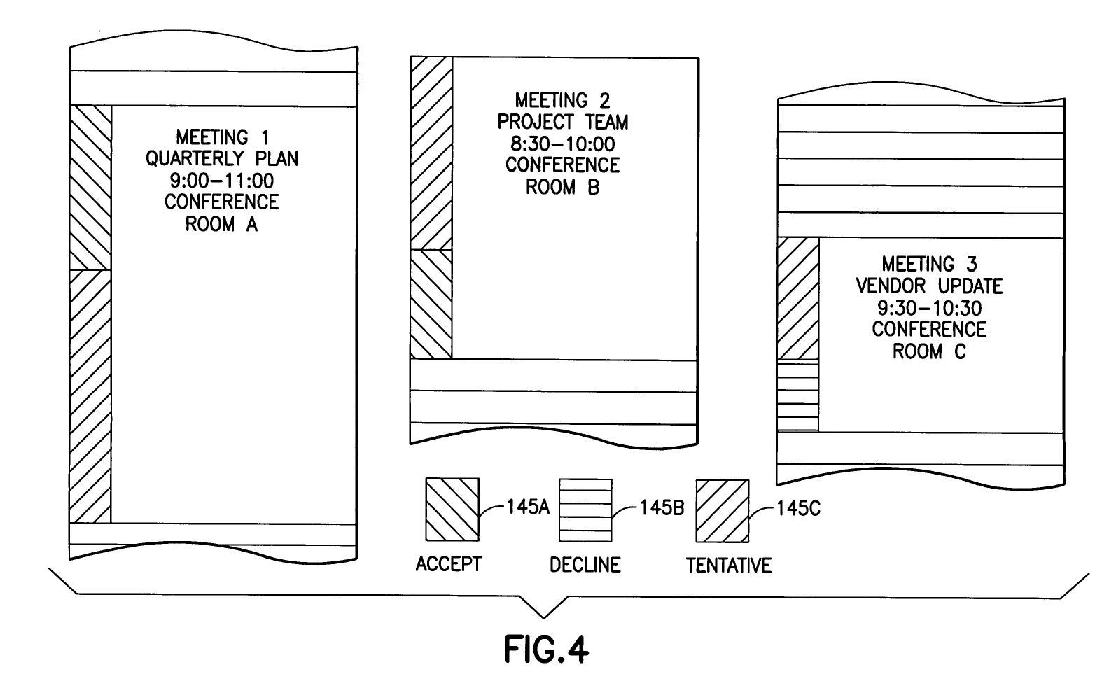

FIG. 4 shows calendar meeting requests or objects in a computerized calendar application as improved by the use of the exemplary embodiments of this invention. Note that in FIG. 4 the invitee has accepted 145A the beginning portion of Meeting 1 and has indicated a tentative acceptance 145C of the remaining portion of Meeting 1. With regard to Meeting 2, the invitee has indicated a tentative acceptance 145C of the initial portion of Meeting 2, and has indicated acceptance 145A of the remaining portion of Meeting 2. With regard to Meeting 3, the invitee has indicated a tentative acceptance 145C of the initial portion of Meeting 3, and has indicated that he declines 145B to attend the remaining portion of Meeting 3. Each displayed Meeting object may be considered to be a displayed invitation that is received from the inviter via a communications network, and that is modifiable in appearance by the user manipulating an user input device, such as a stylus or a mouse or some other type of pointing (or non-pointing) type of user input device.

As can be appreciated, the inviter, when receiving these meeting invitations back from the invitees, has a much clearer indication of how may attendees there will be at different times during the meeting. This information can be used in a variety of ways, such as in determining the size of the meeting room that will actually be required throughout the meeting, as well as when planning for refreshments at different times during the meeting, as two non-limiting examples.

The invitee may select a part of the meeting by using, for example, a stylus, a joystick, a mouse, or by any suitable user input device of an apparatus, such as a computer, that hosts the improved calendar application. After first selecting a portion of a meeting, such as through the use of a stylus, the invitee can select if he wants to accept, tentatively accept or reject the selected portion of the meeting, such as by touching a control button with the stylus. In FIG. 4 the elements 145A, 145B, 145C may be used to represent displayed control buttons that can be activated by the invitee to specify whether a selected portion of a meeting is accepted, declined, or tentatively accepted, respectively.

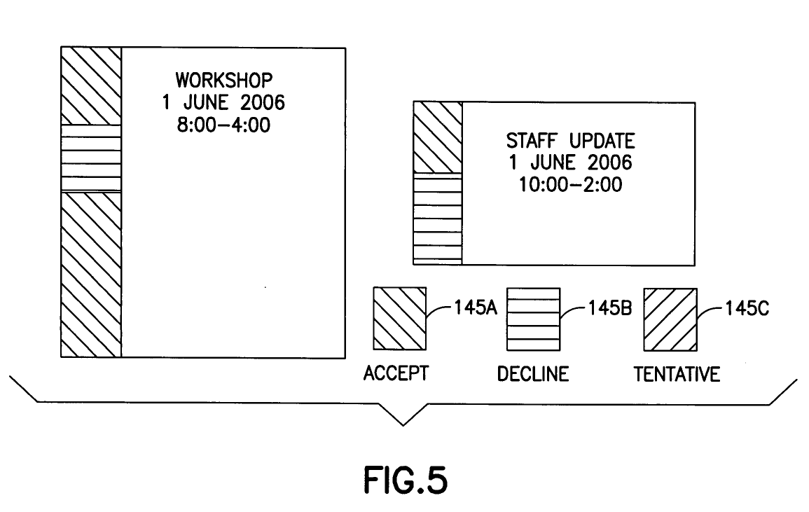

As is shown in the example of FIG. 5, the invitee can accept, tentatively accept or decline different parts of the same meeting. In this non-limiting example a person has been invited to two meetings that are scheduled during an overlapping period of time. In accordance with the exemplary embodiments of this invention the invitee has accepted the beginning portion of the Workshop (e.g., from 8:00 AM until 10:30 AM). She has then declined a next portion of the Workshop and has instead accepted the beginning portion of the Staff Update meeting that begins at 10:30 AM. The invitee has then declined the remaining portion of the Staff Update meeting, and has indicated her acceptance of the remaining portion of the Workshop. This ability to selectively accept, tentatively accept and decline only portions of a meetings is thus clearly an advance over the conventional practice depicted in FIG. 3, where the invitee was enabled to only accept, tentatively accept and decline entire meetings, and not selected portions thereof.

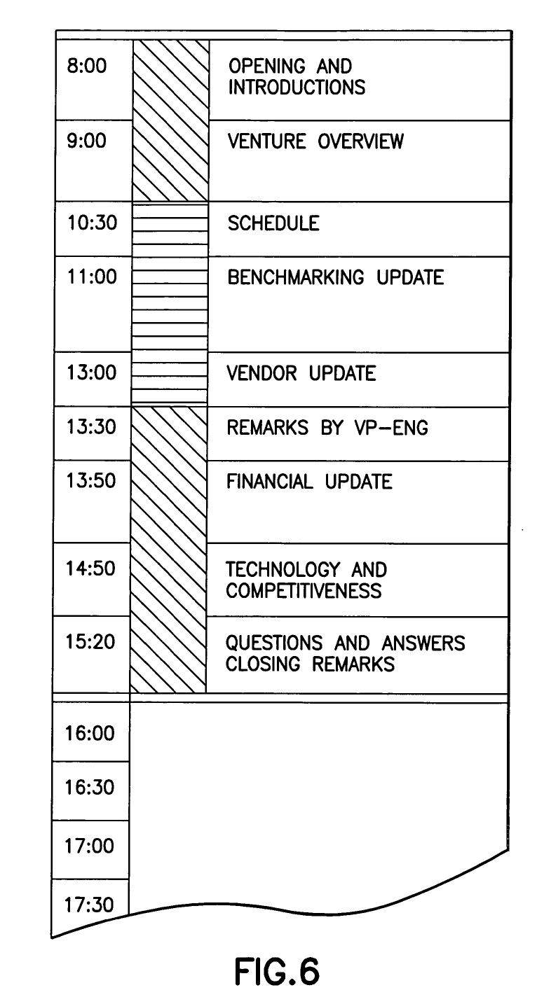

In a further exemplary embodiment a meeting request can include sub-meetings that are part of the meeting request, as shown in FIG. 6. The calendar application is enabled to detect the agenda with hours and mark (e.g., by different colors) different meeting parts in the calendar entry view displayed to the user. Reference can be made to the following example, where rejected part of the meeting is shown in bold and italics. This agenda corresponds to the Workshop meeting shown in FIG. 5.

AGENDA-Workshop

| | |
|---|---|
| 8:00—9:00 | Opening and Introductions |
| 9:00—10:30 | Venture Overview |
| 10:30—11:00 | Schedule |
| 11:00—13:00 | Benchmarking Update |
| 13:00—13:30 | Vendor Update |
| 13:30—13:50 | Remarks by Vice President, Engineering |
| 13:50—14:50 | Financial Update |
| 14:50—15:20 | Technology Competitiveness |
| 15:20—16:00 | Question & Answer, Closing Remarks |

Note that the portion of the meeting that corresponds to the portion that was selectively marked as declined in FIG. 5 is indicated differently in the invitee's calendar entry view, and informs the invitee that she has elected to not attend this portion of the meeting. FIG. 6 illustrates one embodiment of how the different sub-meeting aspect of the invention might be displayed, using the same meeting, attendee responses, and hatching for accept/decline/tentatively accept as in the “Workshop” meeting of FIG. 5. The meeting is divided into nine sub-meetings as indicated at FIG. 6 and the above table. This enables the prospective attendee to better determine which of the sub-meetings are most relevant to him/her and to prioritize his/her schedule so as to accept at least those portions of the meeting most relevant to him/her. Where the sub-meeting option is used, the calendar application may enable the prospective attendee to indicate accept/decline/tentatively accept for only selected portions of the sub-meetings, or to make an indication only as to particular sub-meeting as a whole. This latter option, which is illustrated in FIG. 6, facilitates attendees joining and departing the overall meeting between the distinct sub-meetings rather than disrupting a particular sub-meeting by joining and departing in the midst of a sub-meeting and likely interrupting presentations being made to other attendees.

The calendar application may send each of the sub-meeting requests seriatim rather than as a single meeting request listing sub-meetings. Whether sent as a single meeting request or as different sub-meeting requests, the sub-meeting requests may be displayed as distinct segments of the same overall meeting as shown in FIG. 6. Whether sent separately or as one, the calendar application may optionally indicate certain sub-meetings for which attendance is mandatory. In the meeting of FIG. 6 for example, different persons are to make presentations at different times of the overall meeting. For the invitation sent to the vice president of engineering, the sub-meeting between 13:30 and 13:50 might be indicated as mandatory since he/she will be presenting at that time. Similar for the invitation sent to a representative from the finance division as to the sub-meeting scheduled from 13:50 to 14:50. Such an indication might be the accept/decline/tentatively accept field (hatched column in FIG. 6) for that presenting invitee indicating “attend” when that particular invitee receives the meeting request, and override by the particular attendee is not enabled. Other indications may be implemented, such as color-coding the text field (e.g., the title of the sub-meeting, such as “Remarks by VP-Eng” in FIG. 6) or the time field (shown as the left-most column in FIG. 6 but not shown in other Figures).

Additionally, the sub-meeting aspect of the invention might be used to improve meeting scheduling by enabling prospective attendees to indicate acceptance or tentative acceptance of the sub-meetings individually, dissociated from a time constraint. For example, the meeting request might initially include only the block of time and the list of sub-meetings. Prospective attendees select various sub-meetings as accept, decline, or tentatively accept, but those sub-meetings are not associated with any time other than the overall block of time for the meeting. The meeting scheduler then uses these responses, especially from those scheduled to make a presentation at the meeting, to schedule the sub-meetings within the overall block of time. This may be an automated function based on the responses to the original meeting request. The scheduler than sends a request for confirmation, at least to each prospective attendee that did not reject the entire meeting (all sub-meetings). The request for confirmation may be identical to the original meeting invitation except that the request for confirmation associates time slots with each of the sub-meetings, and optionally may also include the specific attendee's previous responses (to the original meeting request) for accept/decline/tentatively accept. Preferably, the specific attendee can override his previous responses for the individual sub-meetings as those responses are re-produced in the request for confirmation, since he/she may or may not be able to attend a sub-meeting at the time scheduled in the request for confirmation.

An exemplary manner by which the prospective attendee may quickly select more than one sub-meeting is by simultaneously depressing the “CTRL” key and the left mouse button, and holding those two depressed while dragging the cursor over the desired sub-meetings, highlighting them. Releasing them then leaves the highlighted sub-meetings, to which a single user selection of accept/decline/tentatively accept is then applied. This works equally well to select a portion of the overall meeting where sub-meetings are not used. Other manners to enable highlighting specific portions of a meeting request are readily implemented.

Additional field indicators, distinctive from those shown by example as indicative of accept 145A, decline 145B and tentatively accept 145C, may be used to indicate acceptance or tentative acceptance by a specific mode of attendance, such as by teleconference or videoconference. These additional indicators may be displayed in addition to those described with reference to FIGS. 4-6, or may replace them so as to distinctively indicate some combination of accept/tentatively accept and mode of attendance in a single hatching, color, or other indicating scheme.

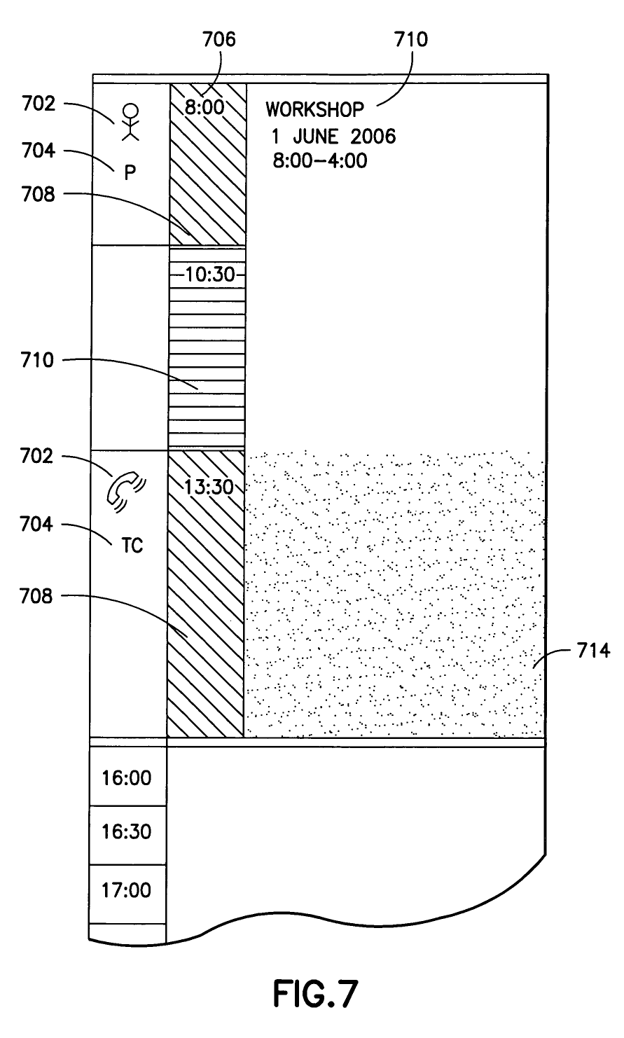

This option is shown in FIG. 7. A first column indicates mode of attendance by icon 702, initials 704, or some other means. For personal attendance, the icon 702 may be a stick figure and the initial 704 may be “P”; for teleconference, the icon 702 may be a telephone handset and the initials 704 may be “TC”; for videoconference, the icon 702 may be a viewing screen or camera and the initials 704 may be “VC”. Other choices are readily embodied. As shown in FIG. 7 but not restricted only to embodiments offering the mode of attendance option, the hatching or other indication of the prospective attendee's responses may be indicted in the time column, overlying the start time 706 for the specific portion of the meeting selected by the attendee as accept 708, decline 710, or tentatively accept (not shown in FIG. 7). Alternatively or additionally, the text field where text 710 specific to the meeting (or sub-meeting) is displayed may indicate mode of acceptance or mode of tentative acceptance. As shown in FIG. 7, no indication is provided in the text field where the attendee accepts or tentatively accepts the default mode, personal attendance in this example. But where the attendee selects other than the default mode, as for the portion of the meeting starting at 13:30 in FIG. 7, the text field may show the indication, whether by icon, initials, shading as shown, colored lettering, or some other manner. In embodiments using a default mode, a response from the prospective attendee to accept 708 or tentatively accept (not shown in FIG. 7) may be displayed as that default mode particular to that meeting (e.g., personal attendance in FIG. 7) unless the prospective attendee makes a further indication of an alternate mode of participation.

An exemplary manner by which the prospective attendee may select mode of attendance is by right clicking a mouse button to display a pull down menu of available attendance modes, then highlighting and selecting one of the modes. This pull down menu may be enabled only when multiple modes of attendance are possible (e.g., personal attendance, teleconferencing or videoconferencing).

Advantageously, the calendar application that sends the meeting request may enable this mode of attendance option for the invitee's response, since typically it is the sender that will know whether teleconferencing or videoconferencing hardware and software will be available for that specific meeting, or whether the meeting organizers authorize alternate modes of attendance. Alternatively, this option may always be available, giving the sender and meeting coordinator the opportunity to gage whether teleconferencing and/or videoconferencing capability will be necessary for the meeting (in which case an addendum to the original meeting request might be sent later to indicate a new location).

Based on the foregoing it can be appreciated that the use of the exemplary embodiments of this invention enables a user to accurately define which part(s) of a meeting that the user can participate in, and thus generally improves the user's experience. Clearly this aids in at least time management and meeting organization. The use of the exemplary embodiments of this invention further aids the meeting organizer, as the meeting organizer is apprised of when meeting participants will join and leave a meeting.

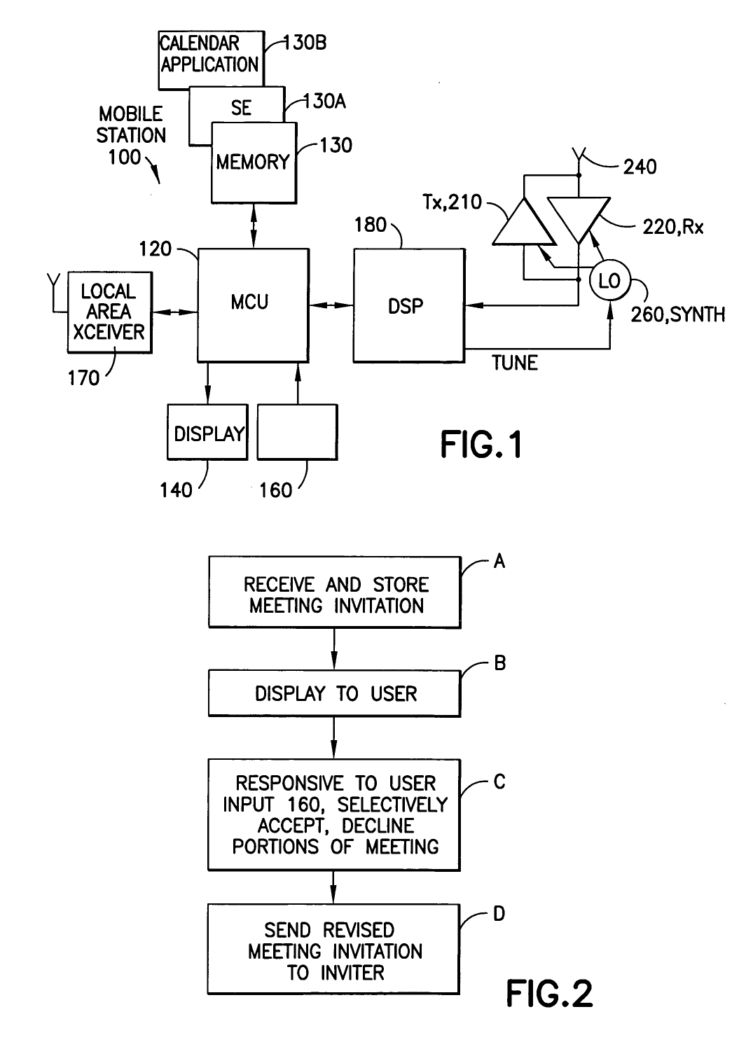

Referring to FIG. 1 there is shown as a simplified block diagram an embodiment of a device, such as a wireless communications device or mobile station 100, that is suitable for practicing the exemplary embodiments of this invention.

It should first be noted that while the exemplary embodiments of the invention will be shown and described as being practiced in a wireless communications terminal, in general the teachings of this invention apply to any type of electronic device that is capable of hosting a calendar/scheduling application software, and that is capable of receiving a meeting request or invitation. Thus, the exemplary embodiments of this invention may be used in desktop computers and workstations, laptop computers, notebook computers and personal digital assistants (PDAs), to name just a few of the many possible devices that can benefit from the use of the exemplary embodiments of this invention. As such, it should be appreciated that the description of the MS 100 in FIG. 1 is not intended to be read in any way as a limitation upon the use and possible implementations of the exemplary embodiments of this invention.

Still referring to FIG. 1, the mobile station 100 typically includes a control unit or control logic, such as a microcontrol unit (MCU) 120 having an output coupled to an input of a display 140 and an input coupled to an output of a user input 160, such as a real or virtual keyboard or keypad and that may include some type of pointing device such as, but not limited to, a stylus, a mouse or a touch-sensitive display screen. The mobile station 100 may be a handheld radiotelephone, such as a cellular telephone or a personal communicator. The mobile station 100 could also be contained within a card or module that is connected during use to another device. For example, the mobile station 10 could be contained within a PCMCIA or similar type of card or module that is installed during use within a portable data processor, such as a laptop or notebook computer.

In general, the various embodiments of the MS 100 can include, but are not limited to, cellular telephones, personal digital assistants (PDAs) and portable computers, and may include or incorporate, as non-limiting examples, image capture devices such as digital cameras, gaming devices, music storage and playback appliances, Internet appliances permitting Internet access and browsing, as well as units or terminals that incorporate combinations of such functions.

The MCU 120 is assumed to include or be coupled to some type of a memory 130, including a non-volatile memory for storing an operating program and other information, as well as a volatile memory for temporarily storing required data, scratchpad memory, received packet data, packet data to be transmitted, and the like. The operating program is assumed, for the purposes of this invention, to enable the MCU 120 to execute the software routines, layers and protocols required to implement the methods in accordance with the exemplary embodiments of this invention, as well as to provide a suitable user interface (UI), via display 140 and user input 160, with a user. Although not shown, a microphone and speaker are typically provided for enabling the user to conduct voice calls in a conventional manner.

Stored in the memory 130 is assumed to be a data structure that is descriptive of at least one scheduled event (SE) 130A, such as a meeting, that is established, managed and used in accordance with the exemplary embodiments of this invention. Associated with the SE 130A is a scheduled event application, which may be referred to for convenience as a calendar application 130B. The calendar application 130B comprises computer executable program code that interacts with the data structure that is descriptive of the SE 130A, and is suitable for use in implementing the exemplary embodiments of this invention, as described more fully below.

The mobile station 100 also contains a wireless section that includes a digital signal processor (DSP) 180, or equivalent high speed processor or logic, as well as a wireless transceiver that includes a transmitter 200 and a receiver 220, both of which are coupled to an antenna 240 for communication with the network operator. At least one local oscillator, such as a frequency synthesizer (SYNTH) 260, is provided for tuning the transceiver. Data, such as digitized voice and packet data, is transmitted and received through the antenna 240. The wireless section may be considered to function as a long range interface (e.g., hundreds or thousands of meters) to a base station coupled to a communications network, such as a cellular operator network and/or the Internet. Note that the MS may also include a local area wireless transceiver (Xceiver) 170, such as one based on Bluetooth™ low power RF or infrared (IR) technology. The local area transceiver 170 may be considered as a short range interface (e.g., meters or tens of meters) for coupling to a wireless local area network (WLAN) via a suitable access point. It is expected that meeting invitations are received through the long and/or short range interfaces, and that modified meeting invitations showing selective acceptance, tentative acceptance and/or rejection, in accordance with the exemplary embodiments of this invention, are sent through the long and/or short range interfaces.

The exemplary embodiments of this invention may be implemented by computer software (e.g., the calendar application 130B) executable by a data processor of the mobile station 100, such as the processor 120, or by hardware, or by a combination of software and hardware. Further in this regard it should be noted that the various blocks of the logic flow diagram of, for example, FIG. 2 (described below) may represent program steps, or interconnected logic circuits, blocks and functions, or a combination of program steps and logic circuits, blocks and functions.

The memory 130 may be of any type suitable to the local technical environment and may be implemented using any suitable data storage technology, such as semiconductor-based memory devices, magnetic memory devices and systems, optical memory devices and systems, fixed memory and removable memory. The data processor(s) 120, 180 may be of any type suitable to the local technical environment, and may include one or more of general purpose computers, special purpose computers, microprocessors, digital signal processors (DSPs) and processors based on a multi-core processor architecture, as non-limiting examples.

Referring to FIG. 2, at Block A the Calendar Application 130B receives from a communications network, and stores in the SE 130A, a data structure that is representative of a meeting invitation. The data structure includes at least start and end times, as well as some text that is descriptive of the meeting purpose and/or agenda. Based on the content of the data structure the Calendar Application 130B at Block B formats the display 140 to present an image, such as one of those shown in FIGS. 4 and 5, to the user (the meeting invitee in this case). This can occur in response to a command from the user, or automatically upon receipt of the meeting invitation. In accordance with the exemplary embodiments of this invention, at Block C the Calendar Application is responsive to an output of the user input 160 to selectively mark the displayed image so as to indicate the user's selective acceptance to attend, tentative acceptance to attend, and/or desire to decline to attend at least two portions of a displayed meeting invitation, as shown in the examples of FIGS. 4 and 5. The underlying data structure stored in the SE 130A is modified accordingly to reflect the user's selective acceptance, tentative acceptance and/or rejection of at least two portions of the meeting. The modified data structure, or another data structure derived from the modified data structure, is then sent to the inviter over the same or a different communications network, via one of the long range or short range interfaces, for indicating to the inviter the invitee's selective acceptance, tentative acceptance or declining to attend two or more portions of the meeting (Block D). Optionally, the time-wise calendar entry view agenda displayed to the user (see the Workshop example above) may then be formulated by the Calendar Application 130B and displayed to the user.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII or the like) may be transmitted to a semiconductor fabrication facility or “fab” for fabrication.

The foregoing description has provided by way of exemplary and non-limiting embodiments a full and informative description of the invention. However, various modifications and adaptations may become apparent to those skilled in the relevant arts in view of the foregoing description, when read in conjunction with the accompanying drawings and the appended claims.

For example, while described above in at least one non-limiting example as the Calendar Application 130B displaying the meeting invitation on the display 140, in other embodiments a remote display could be used, i.e., the calendar application and display need not be co-located in the same device or unit. Also, while described in the context of a meeting, the exemplary embodiments of this invention can be used with any type of scheduled event. As a non-limiting example, an inviter may solicit the invitee to attend a concert where several musicians or ensembles will perform during the day, and the invitee may then selectively indicate which one or ones of several musical performances that the invitee wishes to attend, tentatively attend, or declines to attend. Further, it is within the scope of these exemplary embodiments to enable the invitee to subsequently change his or her selected indications (e.g., change a meeting portion from accept to decline, and vice versa), and to send a revised indication back to the inviter.

However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
displaying an invitation to a scheduled event; and
in response to user input, indicating the user's desire to accept to attend, tentatively accept to attend or decline to attend selected portions of the scheduled event.

2. The method of claim 1, comprising an initial step of receiving the invitation from an inviter over a communications network, and further comprising sending information to the inviter that indicates the user's desire to accept to attend, tentatively accept to attend or decline to attend selected portions of the scheduled event.

3. The method of claim 1, where the scheduled event comprises a meeting, and where the user indicates via the user input that the user desires to attend only a portion of the meeting.

4. The method of claim 3, wherein another user input indicates a mode of participation in at least one of the selected portions.

5. The method of claim 1, wherein the invitation comprises a plurality of sub-meetings of the scheduled event and the selected portions comprise at least some of the sub-meetings.

6. The method of claim 1, wherein the invitation comprises an indication of mandatory attendance for at least one portion of the scheduled event.

7. The method of claim 1, where the scheduled event comprises a meeting, and where the user indicates via the user input that the user desires to tentatively attend only a portion of the meeting.

8. The method of claim 1, where the scheduled event comprises a meeting, and where the user indicates via the user input that the user desires to decline to attend only a portion of the meeting.

9. The method of claim 1, further comprising formulating a time-wise calendar entry view agenda based on the user input and presenting the formulated time-wise calendar entry view agenda to the user.

10. A computer program product embodied in at least one computer readable storage media and comprising program instructions execution of which by at least one data processor results in operations comprising:
displaying an invitation to a scheduled event; and
in response to user input, indicating the user's desire to accept to attend, tentatively accept to attend or decline to attend selected portions of the scheduled event.

11. The computer program product of claim 10, comprising an initial operation of receiving the invitation from an inviter over a communications network, and further comprising an operation of sending information to the inviter that indicates the user's desire to accept to attend, tentatively accept to attend or decline to attend selected portions of the scheduled event.

12. The computer program product of claim 10, where the scheduled event comprises a meeting, and where the user indicates via the user input that the user desires to attend only a portion of the meeting.

13. The computer program product of claim 12, wherein another user input indicates a mode of participation in at least one of the selected portions.

14. The computer program product of claim 10, wherein the invitation comprises a plurality of sub-meetings of the scheduled event and the selected portions comprise at least some of the sub-meetings.

15. The computer program product of claim 10, wherein the invitation comprises an indication of mandatory attendance for at least one portion of the scheduled event.

16. The computer program product of claim 10, where the scheduled event comprises a meeting, and where the user indicates via the user input that the user desires to tentatively attend only a portion of the meeting.

17. The computer program product of claim 10, where the scheduled event comprises a meeting, and where the user indicates via the user input that the user desires to decline to attend only a portion of the meeting.

18. The computer program product of claim 10, further comprising an operation of formulating a time-wise calendar entry view agenda based on the user input and presenting the formulated time-wise calendar entry view agenda to the user.

19. A device, comprising:
at least one data processor;
at least one memory coupled to the at least one data processor;
at least one interface to a communications network that is coupled to the at least one data processor; and
a user interface coupled to the at least one data processor; where
the data processor is responsive to receiving from the communications network an invitation to a scheduled event from an inviter to store data descriptive of the invitation in the memory and to display the invitation to the scheduled event using the user interface, and is further responsive to user input received from the user interface that indicates the user's desire to accept to attend, tentatively accept to attend or decline to attend selected portions of the scheduled event for marking the displayed invitation accordingly.

20. The device of claim 19, the data processor further operable to send information to the inviter that indicates the user's desire to accept to attend, tentatively accept to attend or decline to attend selected portions of the scheduled event.

21. The device of claim 19, where the scheduled event comprises a meeting, and where the user indicates via the user input that the user desires to attend only a portion of the meeting.

22. The device of claim 21, wherein the data processor is further responsive to user input received from the user interface that indicates the user's selected mode of participation in at least one of the selected portions.

23. The device of claim 19, wherein the invitation comprises a plurality of sub-meetings of the scheduled event and the selected portions comprise at least some of the sub-meetings.

24. The device of claim 19, wherein the invitation comprises an indication of mandatory attendance for at least one portion of the scheduled event, and the data processor is not responsive to user input received from the user interface to change said mandatory attendance.

25. The device of claim 19, where the scheduled event comprises a meeting, and where the user indicates via the user input that the user desires to tentatively attend only a portion of the meeting.

26. The device of claim 19, where the scheduled event comprises a meeting, and where the user indicates via the user input that the user desires to decline to attend only a portion of the meeting.

27. The device of claim 19, the data processor further operable to formulate a time-wise calendar entry view agenda based on the user input and to present the formulated time-wise calendar entry view agenda to the user using the user interface.

28. The device of claim 19, embodied in a wireless communications unit.

29. The device of claim 19, embodied in a computer.

30. The device of claim 19, the memory storing a calendar application software that operates the data processor to store, display and mark the invitation.

31. A calendar/scheduling application operable in a device and comprising means for displaying an invitation to a scheduled event and means, responsive to user input, for indicating the user's desire to selectively participate in or not participate in selected portions of the scheduled event.

32. The calendar/scheduling application of claim 31, further comprising means, responsive to receiving the invitation from an inviter over a communications network, for sending information to the inviter that indicates the user's desire to selectively participate in or not participate in selected portions of the scheduled event.

33. The calendar/scheduling application of claim 31, where the scheduled event comprises a meeting, and where the user indicates via the user input that the user desires to attend only a portion of the meeting.

34. The calendar/scheduling application of claim 33, wherein the means responsive to user input is further for indicating a mode of participation in at least one of the selected portions.

35. The calendar/scheduling application of claim 31, wherein the means for displaying an invitation operates to display a plurality of sub-meetings of the scheduled event and the selected portions comprise at least some of the sub-meetings.

36. The calendar/scheduling application of claim 31, wherein the means for displaying an invitation operates to display an indication of mandatory attendance for at least one portion of the scheduled event.

37. The calendar/scheduling application of claim 31, where the scheduled event comprises a meeting, and where the user indicates via the user input that the user desires to tentatively attend only a portion of the meeting.

38. The calendar/scheduling application of claim 31, where the scheduled event comprises a meeting, and where the user indicates via the user input that the user desires to decline to attend only a portion of the meeting.

39. The calendar/scheduling application of claim 31, further comprising means for formulating a time-wise calendar entry view agenda based on the user input and for presenting the formulated time-wise calendar entry view agenda to the user.

40. The calendar/scheduling application of claim 31, where the device is comprised of a wireless communications unit.

41. The calendar/scheduling application of claim 31, where the device is comprised of a computer.
